(19) United States
(12) Patent Application Publication
(10) Pub. No.: US 2022/0250730 A1
(43) Pub. Date: Aug. 11, 2022

(54) Ballistic Engine

(71) Applicant: Horace James, JR., Humble, TX (US)

(72) Inventor: Horace James, JR., Humble, TX (US)

(21) Appl. No.: 16/111,173

(22) Filed: Aug. 23, 2018

(51) Int. Cl. B64B 1/36; F02K 99/00

(52) U.S. Cl. CPC B64B 1/36; B64B 1/12; F02K 99/00

(57) ABSTRACT

An inverted rocket nozzle and pump system suspended and immersed within fluid to be ejected vertically, completely enclosed within an aptly shaped depressurized vessel facilitating vertical propulsion by neutralizing resultant downward thrust and weight of said nozzle and pump system, utilizing the reaction force of fluid jets impinging upon ceiling of said enclosing vessel to induce propulsion.

### BACKGROUND OF THE INVENTION

This invention generally relates to the field of vertical takeoff and lift technologies' means of propulsion. Presently, VTOL aircraft and vehicles employ the use of either wings and propellers or appendages with externally mounted rotors to obtain the propulsive power they need to ascend which limits the scope of their operation to use in open air and wide spaces. The current state of the art is also challenged with the problem of noise pollution as the current use of externally mounted jets, propellers, and rotors produces unacceptable levels of noise within populated areas. This present invention not only addresses this set of problems but also the challenge of efficiency in propulsive power and the economy of energy use. Currently the main method in practice for achieving flight is that which uses the aerodynamic principle of deflecting air across a foil shape. This can be seen in the design of almost all present aircraft including airplanes, helicopters, and aerostats. The limiting factor for these aircraft is either large area planforms are necessary to achieve flight or a considerable number of externally mounted motors; both of which require more power to operate. This invention endeavors to redirect current research in aerodynamics into employing the deflection and expansion of fluids other than air to achieve lift and flight in new ways while also reducing the amount of space necessary to be taken by aircraft, as well as the amount of energy consumed.

### BRIEF SUMMARY OF THE INVENTION

The present invention hereunto pertains to a method and apparatus of facilitating self-contained vertical propulsion by means of vertically ejected fluid jets within an appropriately shaped depressurized pressure vessel constituting the so-called ballistic engine. The object of the aforementioned invention claimed thereof is consolidation of the propulsive means to hereunto allow any such vertical take off and lift vehicle utilizing such an engine to navigate aloft through any municipal or topographically dense area by eliminating the need for large wings and or appendages employing multiple externally mounted rotors or propellers.

### BRIEF DESCRIPTION OF THE DRAWINGS

Note: For simplicity of illustration, valves, gaskets, o-rings, nuts, bolts, bearings, and minutiae of common pressure vessel and aerospace hardware are not depicted for they are known to those with ordinary skill in the art. FIGS. 1-6 depict a preferred embodiment of the invention claimed and is meant purely to convey the spirit of said invention disclosed. These figures do not capture every possible embodiment but are intended to illustrate the nature and spirit of the invention claimed. The embodiment illustrated and described thereof is merely exemplary and is not meant to limit the scope of the invention. The multiple views provided aim to show parts of the invention that may not be totally visible in any one perspective.

FIG. 1 is a front cross-sectional view of the invention. Includes outer encasing vessel.

FIG. 2 is the upper isometric view of the preferred embodiment's nozzle and pump system fitted with the gyrostabilized float system.

FIG. 3 is the top view of the preferred embodiment's nozzle and pump system.

FIG. 4 is the front view of the preferred embodiment's nozzle and pump system.

FIG. 5 is the lower isometric view of the preferred embodiment's nozzle and pump system.

FIG. 6 is a rotated cross-sectional front view of the invention. Includes outer encasing vessel.

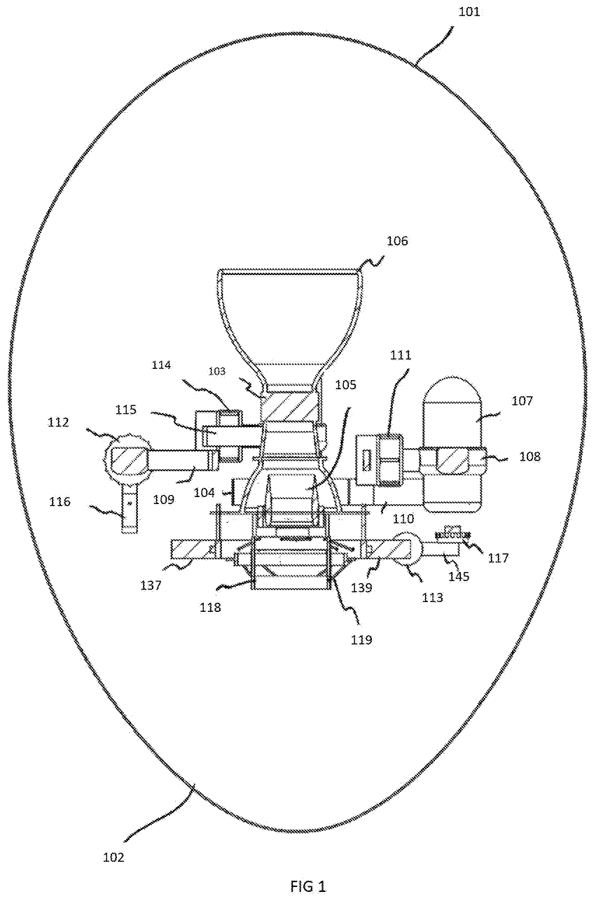

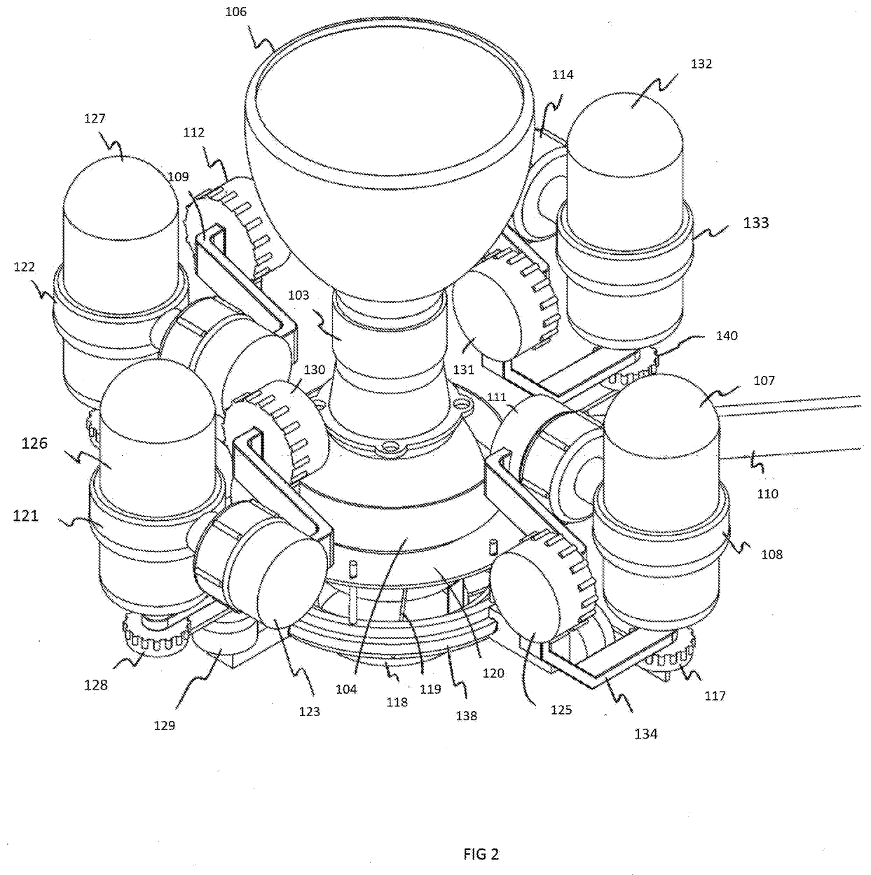

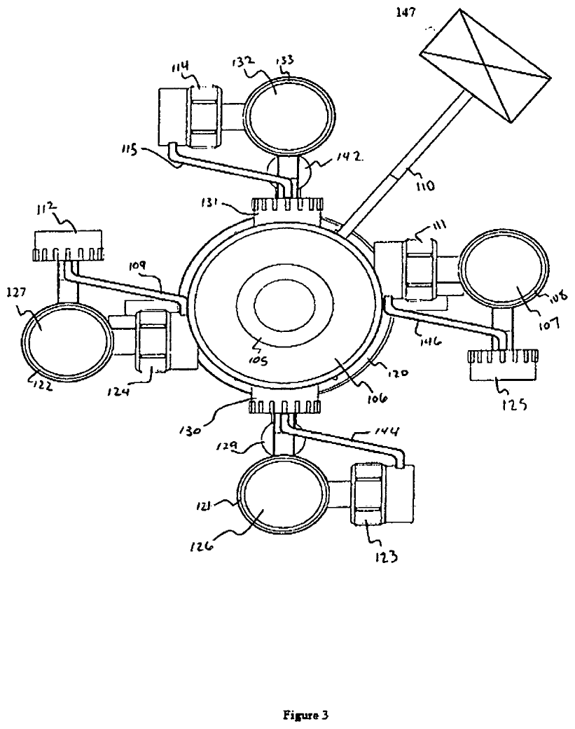

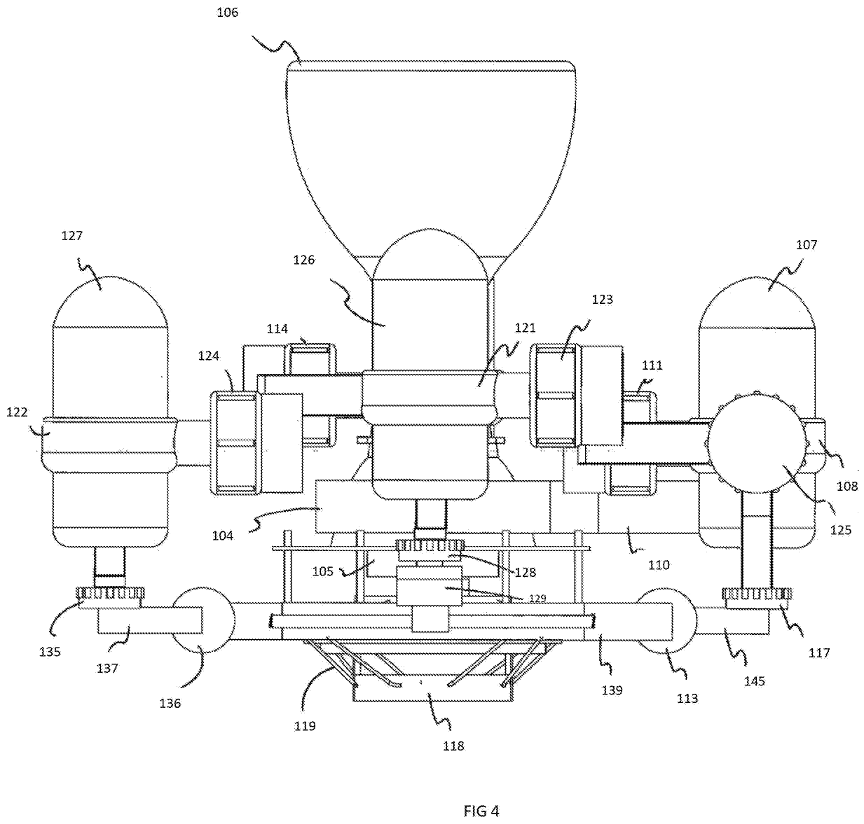

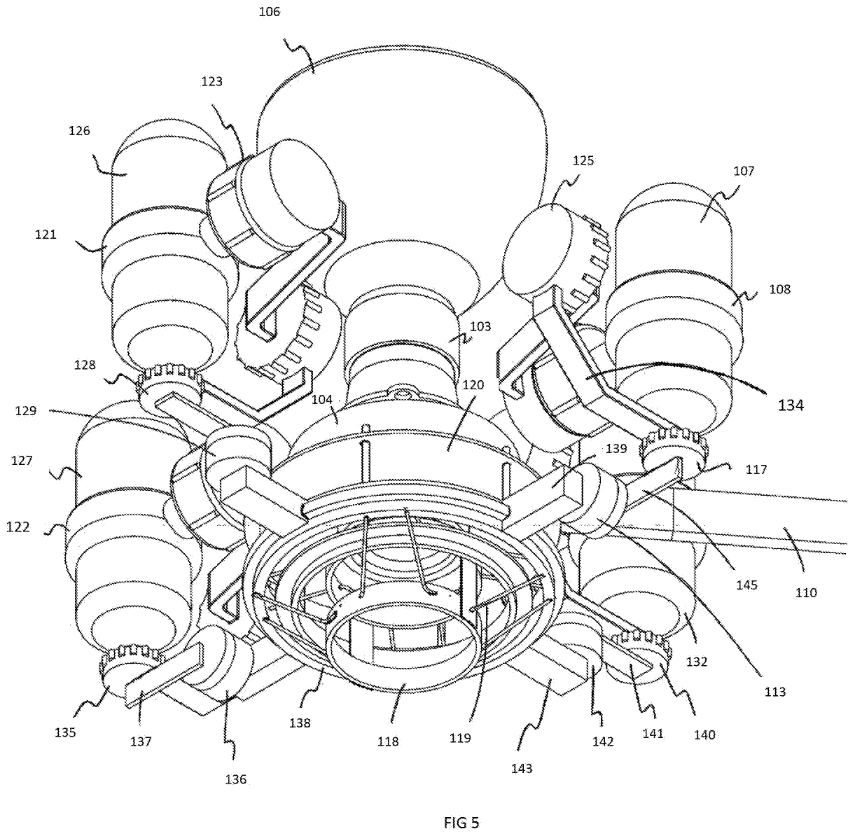

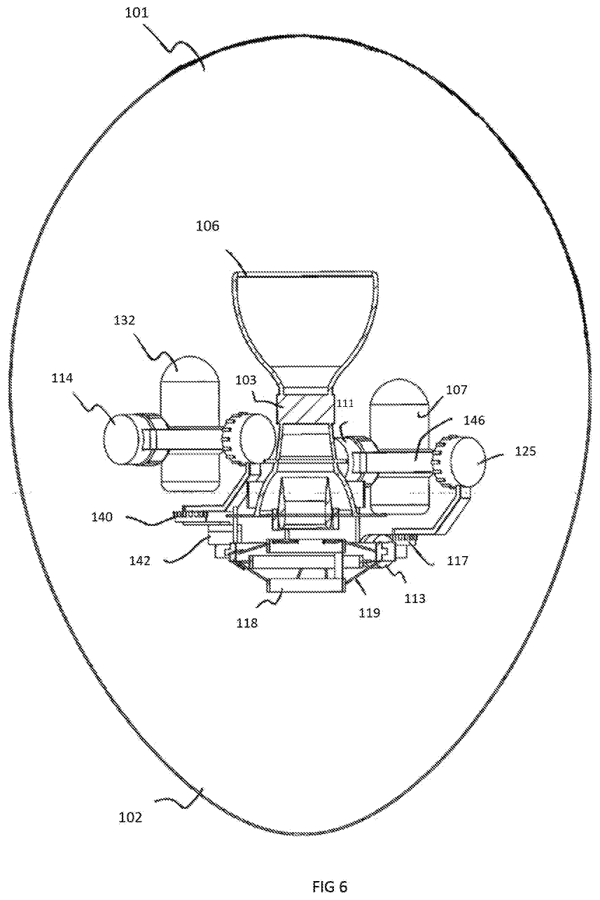

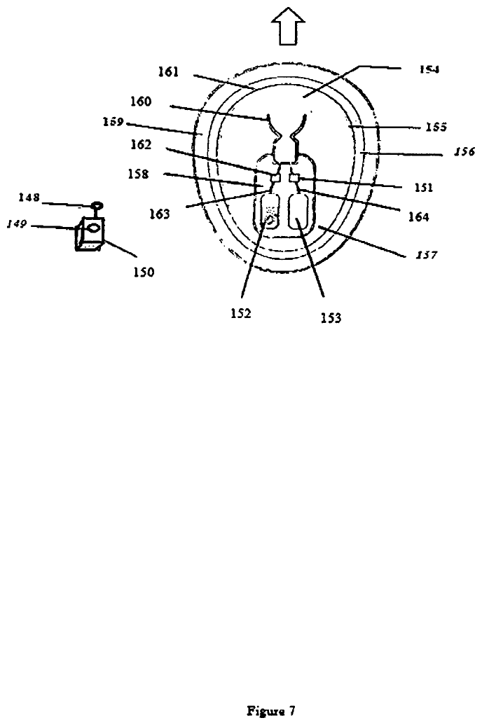

101 is the upper interior curve of the vessel whereas 102 represents the lower bottom interior of the vessel where the liquid phase of the fluid is filled. The vessel should be filled enough to buoy the nozzle and pump system up to the vessels center of gravity, or mass. 103 points to the, throat of the rocket nozzle, or the area separating the nozzle's exit 106 from its inlet where the workpiece to be heated, 105, is housed, surrounded by the induction heater's coil 104. Once the current is run through 104 and oscillated to the frequency necessary to produce the appropriate amount of heat corresponding to the heat of vaporization of the chosen fluid at the given pressure, the fluid will flash upward through 103 and eject out of the exit 106. The ejected jet of vapor will impinge upon the curved ceiling being deflected back from 101 to 102 recondensing and cycling back up through the nozzle pump system continuously. This ejection will cause the nozzle structure to experience a downward force which will be opposed by an equivalent bouyant force provided by cylindrical floats such as the item represented by 107. 108 represents the band holding float 107. 109 is the arm attaching to the motor 124. 110 is the arm of the induction coil 104. 110 extends outside of the vessel and out of view of the figures.

111 is the motor attached to float's 107 band, 108. Each float such as 107 is stabilized by a three axis motor assembly. For example. 107 is stabilized by 111 in the pitch axis, 125 stabilizes the roll axis, and 117 the yaw axis, respectively. 112 is the roll axis motor opposite 125, belonging to float 127. This pattern is repeated in four quadrants centered around the inverted nozzle and pump system. 113 is the roll axis motor stabilizing the nozzle frame structure against float 107's apparent motion. 114 is the pitch axis motor stabilizing float 132 in conjunction with motors 131 and 140. 115 is the arm attaching 114 to 132. Similarly, 116 is the arm attaching 112 to 135, stabilizing 127 in the yaw axis.

117 is the yaw axis motor opposite 135, stabilizing 107. 118 is the base of the shock mount frame employing tension chords as represented by 119 to absorb unwanted vibrations from the fluids passing through the nozzle at high speeds. 118's structure also mounts the induction heater's workpiece 105 within the nozzles inlet.

120 represents the base of the nozzle to which the shock mount frame attatches. 121 and 122 are bands securing 126 and 127 respectively. 123 and 124 stabilize floats 126 and 127 respectively in the pitch axis. 128 stabilizes float 126 in the yaw axis whereas 129 stabilizes the nozzle in the yaw axis against the apparent motions of the floats. In this embodiment the nozzle itself is dual axis stabilized whereas each float maintains triple axis stability. 130 stabilizes float 126 in the roll axis as 131 is the roll axis motor for float 132. 133 is the band securing float 132. 130 is the yaw axis motor opposite 128, just as 142 is the yaw axis motor stabilizing the nozzle against the floats' apparent motion opposite 129. 134 points to an arm connecting roll axis motor 125 to yaw axis motor 117. 136 points to roll axis motor opposite 113. 136 is connected to yaw axis motor 135 by an arm represented by 137. Each limb connecting one of the dual axis stabilizing motors to the frame of the shock mount 118 is attatched to 138, which represents the circumferential band of the shock mount frame through which tensioned chords 119 are strung, absorbing vibration. 145 points to the arm connecting roll axis motor 113 and yaw axis motor 117, which attaches to 138 by arm 139. Following this mode of dual axis stability, yaw axis motor 140 is connected by arm 141 to yaw motor 142, which in turn connects to 138 by way of arm 143. 144 points to the arm in float 126's quadrant connecting roll axis motor 130 to pitch axis motor 123. Following this manner 146 is the arm that connects pitch axis motor 111 to roll axis motor 125, which in turn is connected to yaw axis motor 117 by arm 134.

It is to be appreciated that numerous variations of the invention have been contemplated as would be obvious to one of ordinary skill in the art.

### DETAILED DESCRIPTION OF THE INVENTION

The present invention draws inspiration from the concepts of the parachute, the rocket, and of the balloon. A parachute is commonly a dome shaped fabric device utilizing air resistance to decelerate the fall of a person or object. It is also used as a method of propulsion in the sport of powered parachuting when attached to a small vehicle known as a dune buggy. A balloon is based on the principle of buoyancy where the fluid within an envelope, a lifting gas, is less dense than the surrounding atmosphere insomuch that the amount of space that the balloon occupies yields a net upward force on it according to Archimedes principle. Following this logic, the idea that a balloon “filled with vacuum” arose in the theorization of an airship that is evacuated rather than filled with lighter than air gas to express the power of displacement lift. However, it was concluded that any material capable of sustaining a so-called vacuum balloon would ultimately be too heavy, and the atmosphere that may support this sort of displacement so rare, that the impracticalities outweigh the benefits. This invention employs the presently claimed concept of a sealed, depressurized vessel partially filled with a fluid in its liquid form where a portion of said fluid is either expanded or propelled upwards through a rocket nozzle contained within the vessel. Near vacuum is achieved above the surface of the fluid, allowing the vessel to be filled only with the diffused fluid, preventing over pressurization. In hot air balloons, the air within the envelope is expanded by the application of heat obtained from a fuel source. The air must expand to a volume large enough to produce a buoyant force powerful enough to lift the entire structure. This results in the large sizes of aerostats. This present invention reduces the size of the practical container by utilizing the fluid in its liquid phase such as water, which is approximately 7 to 8 hundred times denser than air. In one embodiment, the liquid is propelled upward through the rocket nozzle via a propeller designed for that fluid. Persons of ordinary skill in the art of pump and rocket design tasked with construction may use their discretion in this area of design. The nozzle may or may not employ the use of a variable area exit and may take on the form of any various nozzle shapes depending upon the nature or scale of application of the invention claimed. In a preferred embodiment the nozzle should take on the form of the optimized bell rocket nozzle as described by G.V.R Rao, and as is used in current aerospace industries. Being inverted, the venturi effect accelerates the fluid upwards through the nozzle, impinging the jettisoned plume against the upper inner surface of the vessel. As the fluid is deflected against the surface, the change in momentum yields an impulse force opposite the deflection. The surface area times the velocity of the fluid, integrated over time yields the change in the vessel's vertical momentum. As the fluid is accelerated upwards, according to Newton's Third Law, the nozzle and pump system suspended within the vessel will experience a downward thrust in addition to its own weight. In any embodiment, these downward acting forces on the nozzle and pump system must be neutralized. The person tasked with construction may use their discretion in selection of the method used to neutralize these forces. This may include pulley and coil systems hoisting the nozzle and pump system, or floats buoying the nozzle and pump system. In the spirit of the invention the nozzle and pump system should be hoisted or suspended to occupy the space constituting the center of gravity of the vessel. This will largely depend upon the shape of the vessel. The vessel may typically take on any shape as set forth by local standardized pressure vessel codes, including capsule or spherical; or that which optimizes the deflection of the fluid against an inner surface of the vessel, propelling the vessel opposite the deflection. The scope of this present invention is in no way limited to use in VTOL aircraft and vehicles, and the effects of which may be utilized in any direction when employing the embodiment of the propeller and nozzle, as long as the reaction forces acting on the nozzle and pump system in the opposite direction are neutralized. It is simply that this invention was originally conceived of for use in the vertical direction, away from any celestial body's center of mass. The inner and outer surfaces of the vessel may also employ the use of ailerons or deployable foils to induce a torque upon the body of the vessel upon impingement of fluid jets. In the preferred embodiment the nozzle should make use of a vaporizer, or electric heating element to expand a portion of the liquid into its gaseous phase, jettisoning the vapor plume in the same aforementioned manner upward through the nozzle within the vessel. It is left to the discretion of the person tasked with construction according to the scale of application to decide which embodiment is appropriate, without departing from the spirit of the invention. In this preferred embodiment the vessel will take the shape approximating the Cassini oval, curve defined by Cartesian coordinates (a²+x²+y²)²−4 a² x² −b⁴ =0, where a=1.01, and b=1. This curve should resemble the form of an egg where the wider side points away from the celestial body's center of mass, and with the narrower side closer to its surface. Within this preferred embodiment the nozzle and pump system may be suspended in the fluid using a buoyant frame made of polyurethane or aerogel composites, or a system of floats that may be gyroscopically stabilized in a manner familiar in the marine, mobile, and even film industries as is seen within cellular devices, drones and Steadicams. As the fluid is jettisoned upward through the nozzle and pump system, said system will experience induced vibrations and instabilities from turbulence produced by eddies and vortices shedding as the fluid passes through the induction heater's workpiece. The workpiece itself may take the cross-sectional shape of a foil to facilitate advective flow dominated by buoyant forces. Stability may be achieved by employing accelerometers that will sense the apparent motions of the nozzle and pump system, sending feedback signals to motorized gimbals that produce counter torques to induced rolling moments around the nozzle. In a preferred embodiment stabilizing motors may be further augmented by the incorporation of a shock mount system into the frame of the nozzle and pump system. This shock mount may be fitted with spring loaded shock absorbers and or strung with tensioned chords designed according to Mersenne's laws to cancel out resonant vibrations within the vessel. Mersenne's laws describe the frequency of oscillation of stretched chords and may be used to design tensioned chords that will, produce destructive interference with resonant frequencies in any induced vibrations. In this preferred embodiment the heating element should take the form of an induction, heating coil, laminated to be water proof and moisture resistant, surrounding the inlet of the nozzle with the inner work piece being an electrically conducting material such as stainless steel, placed and secured within the inlet according to its own design. In induction heating heat is generated within the workpiece itself by an electronic oscillator passing high frequency alternating current through an electromagnet. No external contact is necessary thus allowing for efficient transfer of heat energy by immediate vaporization of fluid in contact with the workpiece, whose total surface area should correspond with the molar mass of fluid to be vaporized. The nozzle inlet design should incorporate a method of insulation that allows for this precise amount of fluid to be expanded to protect against vapor explosion. This may be achieved by applying a reflective coat on the inner surface of the nozzle inlet akin to the silvering technique as is used by vacuum thermos containers. Measures may also be taken to maintain a constant internal temperature within the vessel to conserve enthalpy. This may be achieved by the incorporation of a cooling system designed to remove a constant amount of heat from the vessel, corresponding to the input heat plus any heat accumulated from friction. Recommended materials for the vessel construction may include Kevlar, aluminum, or ceramic composite materials. Teflon may be desirable to use on the inner surface of the vessel with a hydrophobic epoxy resin coating the impact surface to maximize fluid velocity.

I claim:

1. Method of propulsion comprising nozzle enclosed and suspended within vessel to eject fluid in direction of sought propulsion, utilizing deflection of said fluid against inner surface of said vessel.

2. Method of propulsion according to claim 1 consisting of vaporization of fluid via the induction heating of foil shaped workpiece in direct contact with fluid within rocket, nozzle and pump system.

3. Method of neutralizing resultant thrust and imbalance of said suspended nozzle according to claims 1 and 2 by way of gyroscopic stabilizing float system.
